(19) United States
(12) Patent Application Publication
(10) Pub. No.: US 2004/0077092 A1
(43) Pub. Date: Apr. 22, 2004

(54) Control and calibration material for blood coagulation tests

(76) Inventors: Hans Wielinger, Weinheim (DE); Rainer Fuellemann, Weinheim (DE); Erika Abel, Mannheim (DE)

Correspondence Address: Roche Diagnostics Corporation, 9115 Hague Road, PO Box 50457, Indianapolis, IN, 46250-0457, US

(21) Appl. No.: 10/437,827

(22) Filed: May 14, 2003

(30) Foreign Application Priority Data
May 16, 2002 (DE) 102 22 234.7

(51) Int. Cl. G01N 1/00

(52) U.S. Cl. 436/10; 422/61

(57) ABSTRACT

Control and calibration material for blood coagulation tests The invention concerns control and calibration materials for coagulation tests which contain plasma and a substance or a mixture of substances which prolongs the clotting time of the plasma.

The invention concerns control and calibration materials for the quality control and calibration of coagulation tests, and the production and use thereof.

Examinations of coagulation physiology are carried out in hospitals, medical practices, laboratories etc. for preoperative examinations, for detecting bleeding and thrombosis risks, to monitor anticoagulant therapy in patients with a risk of thrombosis and for the follow-up of numerous diseases such as severe infections, liver dysfunction and malignant diseases. The prothrombin time is increasingly being determined by the patients themselves for the self-monitoring of anticoagulant therapy. Quality control is an absolute essential for all these examinations in order to monitor the test system and to acquire results with the utmost reliability.

The coagulation tests that are most frequently carried out are global tests in which the function of several factors involved in the coagulation process and their interaction in the coagulation cascade is determined simultaneously. The most important global tests are the so-called prothrombin time test (abbreviated PT) which is also referred to as the Quick test, the so-called activated partial thromboplastin time test (aPTT) and the determination of the activated clotting time (ACT). In all these tests one measures the time which elapses from the start of the corresponding coagulation process with the respective reagent until the coagulation process is completed. The coagulation process is completed when a clot has formed. The coagulation process is typically monitored using secondary phenomena that can be observed in the sample (e.g. by means of turbidity measurements, measuring the light scattering, the conductivity, the viscosity or the activity of key enzymes in the coagulation cascade such as thrombin).

Control and calibration materials are required for the quality control and calibration of these methods which can be used to monitor or calibrate the normal range (i.e. samples having a normal, not prolonged clotting time) and also the ranges with prolonged clotting times (so-called pathological range).

Lyophilized plasmas, preferably citrate plasmas are usually used as control and calibration materials (also referred to as control materials in the following for the sake of simplicity). These plasmas are usually obtained from animal blood. The lyophilisates are rehydrated with distilled water or buffer solutions before use. In order to produce control materials for pathological ranges (i.e. for samples with prolonged clotting times compared to the normal range) it is necessary according to the present state of the art to employ a relatively complicated process to generate control materials with increased clotting times starting from plasmas with clotting times in the normal range. For this purpose the plasmas are chromatographed on columns filled with barium sulfate. A portion of the coagulation factors is bound to the barium sulfate which has the effect that the clotting times are increased in the coagulation factor-depleted plasmas obtained in this manner.

It is obvious to a person skilled in the art that it is difficult to obtain very reproducible results with the current conventional processes for producing control materials for the pathological range and that the desired clotting times have to be adjusted before the lyophilization step by additionally mixing coagulation factor-depleted plasmas with untreated plasmas. Furthermore this process is time-consuming and requires a large amount of material and is hence expensive.

The object of the present invention was to provide a process for producing control and calibration materials for the pathological range of coagulation tests and preferably global tests which is simpler and hence cheaper than conventional processes. A further goal is to provide control materials which can be produced in a simpler and more reproducible manner than conventional materials.

This object is achieved by the subject matter of the invention as defined in the independent patent claims. Preferred embodiments of the invention are the subject matter of the dependent claims.

Substances such as urea (or derivatives or salts thereof) or guanidine (or derivatives or salts thereof) are known which have the property of denaturing proteins by influencing their secondary and/or tertiary structure by partially uncoiling them (cf. e.g. Lubert Stryer, “Biochemie”, 1990, “Spektrum der Wissenschaft Verlagsgesellschaft mbH”, 6900 Heidelberg, pages 32-34). These and other compounds are also described as fibrin precipitation inhibitors in U.S. Pat. No. 5,508,202, column 4, lines 31 to 51 (explicit reference is herewith made to this passage in its entirety and to the substances mentioned therein) which are used to improve the determination of the activity of factor XIII (abbreviated to F XIII in the following). For this the fibrin precipitation inhibitors are added to the sample in which it is intended to determine the F XIII activity, a solution of thrombin and calcium ions is added to start the last stage of the coagulation cascade and the time is measured which elapses until a clot has formed in the sample. The clotting times of the patient plasmas are compared with the clotting time of normal plasma in the above-mentioned method in order to determine the F XIII activity in the sample.

It has surprisingly turned out that control and calibration materials for global coagulation tests can be produced in a simpler, more economical and reproducible manner when the above-mentioned substances (fibrin precipitation inhibitors) are directly added to the plasmas that are to be used as control materials for the pathological range or are added to the solution that is used to rehydrate the lyophilized plasmas. Surprisingly the clotting times are increased in control plasmas obtained in this manner. The substances that are suitable according to the invention are also referred to in the following as “prolongation substances”.

All compounds have turned out to be suitable as prolongation substances according to the invention which have the above-mentioned properties and mixtures thereof. Guanidine and urea are particularly suitable especially for cost reasons, but N-substituted guanidines and N-substituted ureas and salts of these classes of substances can also be used according to the invention.

It has turned out that the increase in the clotting times is linearly proportional to the added concentration of these prolongation substances. For this reason it is possible to select concentrations of these substances over a wide range depending on the extent to which the clotting times of the control materials are to be extended. For practical reasons concentrations of ca. 0.5 to ca. 6.0 percent by weight have proven to be particularly favourable. However, it is also possible to achieve the inventive effect with lower or higher concentrations of the prolongation substances.

The control and calibration materials according to the invention are prepared as follows:

Variant 1:

After pooling the plasmas (i.e. mixing plasmas from different donors), the prolongation substance is dissolved in the pooled plasma at the concentration required to prolong the clotting time. The pooled plasma is usually subsequently dispensed in small portions into small vessels and lyophilized.

The lyophilized plasma is dissolved in water or buffer solutions for use and is measured in an otherwise identical manner to a sample. After determining the corresponding target values the material prepared in this manner can be used as a control or calibrator.

Variant 2:

Lyophilized plasma which is used as a control in the normal range is dissolved with solutions of the prolongation substances. The control prepared in this manner is measured like a sample. Before its final use as a control or calibration material it is of course necessary to determine the corresponding target values for the combination of the prolongation substance solution and normal control.

The invention is elucidated by the following examples without, however, being limited thereby:

### EXAMPLE 1

Production and Use of the Inventive Control and Calibration Material for the Product CoaguChek® Pro (test for determining the prothrombin time) from Roche Diagnostics

### EXAMPLE 1a)

Effect of the Prolongation Substance when Added to Plasma for the Production of the Control and Calibration Material.

Citrate plasma that was obtained from rabbits was processed further as follows.

A portion of the citrate plasma is left untreated and filled in 3.0 ml portions into siliconized vessels and lyophilized. The remainder of the plasma is used to produce preparations to which 2.0%, 3.5% and 5.0% urea (in each case % by weight) is added in each case to the plasma as the prolongation substance. These mixtures are also filled in 3.0 ml portions and lyophilized.

After rehydration of the individual preparations with distilled water, the samples obtained in this manner are added dropwise to test cards of the CoaguChek® Pro from Roche Diagnostics and the seconds which elapse until the onset of coagulation is determined on the accompanying measuring instrument CoaguChek® Pro.

The following table 1 shows the effect of added urea:

TABLE 1

| Concentration of urea | time until the onset |
|---|---|
| (% by weight) | of coagulation (s) |
| 0.0 | 17.0 |
| 2.0 | 22.9 |
| 3.5 | 29.6 |
| 5.0 | 41.2 |

### EXAMPLE 1b)

Effect of the Prolongation Substance when Added to the Rehydration Solution

Commercial control material level 1 for the CoaguChek® system (test for determining the prothrombin time) from Roche Diagnostics is rehydrated with aqueous solutions which contain 0.0%, 1.0%, 3.0%, 4.0% and 5.0% urea (in each case % by weight). These solutions are subsequently measured with the CoaguChek® system (test plus measuring instrument).

The following table 2 shows the effect of the added urea:

TABLE 2

| Concentration of urea | |
|---|---|
| (% by weight) | time until the onset |
| in the rehydration solution | of coagulation (s) |
| 0.0 | 17.0 |
| 2.0 | 19.3 |
| 3.0 | 28.1 |
| 4.0 | 32.2 |
| 5.0 | 37.8 |

### EXAMPLE 2

Effect of the Inventive Prolongation Substances when Added to Control Plasmas to Monitor the Determination of aPTT (activated partial thromboplastin time)

### EXAMPLE 2a)

Effect of N-methyl-urea

The control plasma “PreClot I/II” from Roche Diagnostics is rehydrated according to the instructions of the manufacturer with aqueous solutions in which 0%, 2.0%, 3.5% and 5.0% N-methyl urea (in each case % by weight) are dissolved. The “PTT a reagent for the automated and manual determination of the activated partial thromboplastin time” from Roche Diagnostics is used to determine the clotting time in seconds in the control solutions obtained in this manner on a ball coagulometer KC10A from the Amelung Company (Germany).

The following table 3 shows the effect of the added N-methyl-urea:

TABLE 3

| Concentration of N-methyl-urea | |
|---|---|
| (% by weight) | time until the onset |
| in the rehydration solution | of coagulation (s) |
| 0.0 | 31.0 |
| 2.0 | 34.0 |
| 3.5 | 38.6 |
| 5.0 | 44.0 |

### EXAMPLE 2b)

Effect of Guanidine Hydrochloride

The experimental protocol is the same as described in example 2a).

The only amendment was that the following concentrations of guanidine hydrochloride were added to the rehydration solution (in each case % by weight): 0%, 0.5% 1.0% and 1.5%.

The following table 4 shows the effect of the added guanidine:

TABLE 4

| Concentration of guanidine | |
|---|---|
| (% by weight) | time until the onset |
| in the rehydration solution | of coagulation (s) |
| 0 | 31.0 |
| 0.5 | 33.1 |
| 1.0 | 41.9 |
| 1.5 | 51.8 |

### EXAMPLE 3

Effect of the Prolongation Substances According to the Invention when Added to Control Plasmas to Monitor the Determination of the Activated Clotting Time (ACT)

Effect of Guanidine

The lyophilized control plasma “ACT quality control CoaguChek® Pro system level 1” from Roche Diagnostics was rehydrated with the supplied rehydration solution according to the instructions of the manufacturer. 0%, 0.25%, 0.5% and 0.75% guanidine hydrochloride (in each case % by weight) were added to these solutions. Subsequently the ACT test cassettes of the CoaguChek® Pro system from Roche Diagnostics and the corresponding measuring instrument were used to determine the time in the control solutions prepared in this manner which elapses until the instrument displays the onset of coagulation in the control plasma preparations which were pipetted into the test cassettes.

The following table 5 shows the effect of the added guanidine:

TABLE 5

| Concentration of guanidine | |
|---|---|
| (% by weight) | time until the onset |
| in the rehydration solution | of coagulation (s) |
| 0 | 150.1 |
| 0.25 | 175.6 |
| 0.5 | 223.4 |
| 0.75 | 305.6 |

1. Control and/or calibration material for coagulation tests containing plasma and a substance or a mixture of substances which prolongs the clotting time of the plasma.

2. Control and/or calibration material as claimed in claim 1, characterized in that the substance or the mixture of substances which prolongs the clotting time of the plasma is able to change the secondary and/or tertiary structure of proteins which are involved in the coagulation cascade.

3. Control and/or calibration material as claimed in claim 1 or 2, characterized in that the substance or mixture of substances which prolongs the clotting time of the plasma uncoils proteins.

4. Control and/or calibration material as claimed in claim 1, 2 or 3, characterized in that the substance or mixture of substances which prolongs the clotting time of the plasma is urea or a urea derivative or a salt of urea or a salt of a urea derivative.

5. Control and/or calibration material as claimed in claim 4, characterized in that the urea derivative is guanidine or a guanidine derivative.

6. Control and/or calibration material as claimed in claim 1, 2, 3, 4 or 5, characterized in that the substance or mixture of substances which prolongs the clotting time of the plasma is used in amounts of 0.5 to 6% by weight.

7. Use of substances or mixtures of substances which prolong the clotting time of plasma as an additive for producing control or calibration materials for the pathological range for coagulation measurement.

8. Use as claimed in claim 7, characterized in that the substance or mixture of substances which prolongs the clotting time of the plasma is able to change the secondary and/or tertiary structure of proteins which are involved in the coagulation cascade.

9. Use as claimed in claim 7 or 8, characterized in that the substance or mixture of substances which prolongs the clotting time of the plasma uncoils proteins.

10. Use as claimed in claim 7, 8 or 9, characterized in that the substance or mixture of substances which prolongs the clotting time of the plasma is urea or a urea derivative, or a salt of urea or a salt of a urea derivative.

11. Use as claimed in claim 10, characterized in that the urea derivative is guanidine or a guanidine derivative.

12. Use as claimed in claim 7, 8, 9, 10 or 11, characterized in that the substance or mixture of substances which prolongs the clotting time of the plasma is used in amounts of 0.5 to 6% by weight.

13. Use of a control and/or calibration material as claimed in claim 1, 2, 3, 4, 5 or 6 for the control or calibration of coagulation measuring systems.

14. Process for producing a control and/or calibration material as claimed in claim 1, 2, 3, 4, 5 or 6 comprising the steps
providing a plasma, dissolving the substance or mixture of substances which prolongs the clotting time of the plasma in the plasma and optionally lyophilizing and rehydrating the mixture.

15. Process for producing a control and/or calibration material as claimed in claim 1, 2, 3, 4, 5 or 6 comprising the steps
providing a lyophilized plasma and rehydrating the plasma with a solution of the substance or mixture of substances which prolongs the clotting time of the plasma.

16. Kit for the control or calibration of coagulation measuring systems comprising
lyophilized plasma and a substance or mixture of substances which prolongs the clotting time of the plasma.
